(19) United States
(12) Patent Application Publication
(10) Pub. No.: US 2026/0102794 A1
(43) Pub. Date: Apr. 16, 2026

(54) APPARATUS AND METHOD FOR DECONTAMINATING PLASTICS

(71) Applicant: PIOVAN S.P.A., Santa Maria di Sala (VE) (IT)

(72) Inventors: Enrico BELLIO, Ponzano Veneto (IT); Davide CAPPELLINI, Soncino (IT)

(73) Assignee: PIOVAN S.P.A., Santa Maria di Sala (VE) (IT)

(21) Appl. No.: 19/116,630

(22) PCT Filed: Nov. 27, 2023
(86) PCT No.: PCT/IB2023/061923

§ 371 Date: Mar. 28, 2025

(30) Foreign Application Priority Data
Dec. 23, 2022 (IT) 102022000026727

(51) Int. Cl. B08B 3/12; B29B 17/02

(52) U.S. Cl. CPC B08B 3/12; B29B 17/02; B29B 2017/0286

(57) ABSTRACT

A method of decontamination for decontaminating plastics in solid particulate form includes the steps of: loading the plastics into a tank; introducing a liquid into the tank so that the liquid is in contact with the plastics; hitting the plastics in the tank and the liquid in contact with the plastics with ultrasonic waves. A decontamination apparatus actuates the decontaminating method and a plant includes the decontamination apparatus.

### TECHNICAL FIELD

The invention relates to a method and an apparatus for decontaminating plastics, in particular for decontaminating plastics in solid particulate form, i.e. in the form of granules and/or microgranules and/or pellets and/or powder and/or flakes or the like.

Specifically, but not exclusively, the invention can be applied to decontaminating polymer granules suitable for extrusion and/or moulding processes and made with plastics obtained from post-consumer plastics (PCR recycled after consumption).

The invention can be applied to plastics in solid particulate form obtained from recovered plastics that have undergone at least one extrusion treatment. In particular, the invention can be applied to plastics in solid particulate form obtained from recovered plastics that have undergone waste sorting and/or washing and/or decontamination and/or deodorization and/or extrusion.

### BACKGROUND OF THE INVENTION

In the sector of the transformation of plastics into a finished product, plastics obtained from post-consumer resin (PCR) are being used increasingly. However, using plastics obtained from post-consumer resin, particularly in the food packaging industry, makes decontamination interventions necessary aimed at eliminating contaminating substances, including acetaldehyde, benzene, toluene, limonene, etc, which are also known as NIAS (non-intentionally added substances), which are a health risk. Such contaminants remain present in the polymer matrix even after the treatments (in particular, waste sorting, washing, decontamination and deodorization) to which the recovered plastics are subjected before transformation into plastics in solid particulate form by extrusion processes.

Different techniques are known that are suitable for ensuring the decontamination of polymer granules for use in the food packaging industry. Such techniques comprise, for example, vacuum treatments, degassing and fluxing with inert gases at a controlled temperature. However, known techniques do not ensure effective decontamination and deodorization of the plastics. In fact, recycled plastics treated by known decontamination techniques in general contain contaminants that limit the use thereof in food applications. In other words, the use of recycled plastics is limited in food packaging. Further, known techniques are costly from the energy point of view and have a great impact on the environment.

It is accordingly desirable to minimize or eliminate the presence of contaminants like acetaldehyde, benzene, limonene, toluene and other NIAS that may be present in recycled plastics in solid particulate form, to obtain recycled plastics in solid particulate form that have a high degree of decontamination and can be used to produce, for example, food packaging without risks to health. In addition, it is desirable to reduce energy consumption and the environmental impact of treatments for decontaminating plastics, further reducing treatment times.

The prior art further comprises techniques for extracting molecules from particulate solid matrices. The prior art further comprises techniques for extracting molecules from particulate solid matrices. In this respect, patent publication WO 2021/090250A1 discloses a process and a system for extracting solutes dispersed in solid particles that is not, however, applied to decontaminating plastics.

### SUMMARY OF THE INVENTION

One object of the invention is to make available an alternative solution to those of the prior art for decontaminating plastics in solid particulate form, in particular obtained from recycling, minimizing and/or eliminating the presence of contaminants such as acetaldehyde, benzene, toluene, limonene and other NIAS.

One object of the invention is to propose a solution that is suitable for overcoming one or more of the aforesaid limits of the prior art.

One advantage is to reduce the number of decontamination cycles to which the plastics to be decontaminated are subjected.

One advantage is to reduce energy consumption for decontaminating plastics in solid particulate form and/or diminishing the environmental impact of the decontamination process. Other advantages are increasing productivity and decreasing the duration of the decontamination process.

Such objects and advantages, and still others, are achieved by a method and/or an apparatus and/or a plant according to one or more of the attached claims.

In one embodiment, a decontamination apparatus comprises a tank configured to contain plastics in solid particulate form (also called below, for the sake of concision, plastics or granules of plastics or polymer granules); at least one ultrasonic wave generator configured to emit waves in the tank; a liquid circuit with a supply duct configured to feed a liquid (for example water) to the tank, with a discharge duct configured to discharge the liquid exiting the tank, and with a purifier configured to purify the liquid of at least one contaminant and arranged so as to purify the liquid received from the discharge duct and release the purified liquid to the supply duct.

In one embodiment, a method of decontamination for decontaminating plastics comprises the steps of loading the plastics into a tank, introducing a liquid (for example water) into the tank so that the liquid is in contact with the granules of plastics, hitting the granules of plastics and the liquid with ultrasonic waves. Further, it is possible to provide the step of controlling one or more process parameters, such as the pressure of the liquid in the tank, temperature of the liquid (in the tank and/or entering the tank and/or exiting the tank), supply/discharge flowrate of the liquid to the/from the tank, dwell time of the liquid in the tank, dwell time of the plastics in the tank, intensity of the ultrasonic waves, frequency of the ultrasonic waves.

In particular, the method may comprise the step of determining the contamination of the plastics to be treated (i.e. the amount of one or more contaminants present in the plastics before the decontamination process). In this manner it is possible to determine a maximum amount of at least one contaminant to be extracted, and this maximum amount may be set as a removal limit value. In order to determine the aforesaid amount of one or more contaminants present in the plastics, the technique of gas chromatography may be used for example.

The method disclosed may comprise the detecting step of detecting an amount of at least one contaminant present in the liquid exiting the tank. This detecting step enables the amount of at least one contaminant extracted from the plastics to be known and to accordingly establish whether to repeat the steps of decontamination, or modify the process parameters, or deem decontamination to be excluded. The liquid exiting the tank may be, for example, analyzed by a sensor arranged downstream of the tank to detect the presence of at least one contaminant. The analysis of the liquid exiting the tank enables the capacity to be established of the decontamination process to extract one or more contaminating substances present in the recycling plastics and one or more parameters of the decontamination process to be adjusted accordingly.

In particular, as an initial amount of at least one contaminant present in the plastics is known and as an amount of the contaminant present in the liquid exiting the tank is known, it is possible to determine a degree of contamination of the plastics present in the tank, for example during the decontamination steps. One or more parameters of the decontamination process may be accordingly adjusted on the basis of the degree of contamination of the plastics present in the tank.

In particular, after a set process time, if it is detected that the amount of contaminant extracted from the plastics is less than a reference value, it is possible to modify at least one parameter governing the use of ultrasound, for example the power, the frequency, the emission ratio (i.e. considering an intermittent emission of the ultrasound for a certain period of time, the relation between the period of time of actual emission of the ultrasound and the total period of time). It is known that the ultrasonic waves can be emitted at a constant intensity or in pulse trains. If the amount of contaminant extracted from the plastics is much lower than the reference value it is possible to modify (increase) the intensity of the ultrasound and/or the temperature of the liquid in the tank.

The decontamination process may be performed by alternating dynamic steps of washing of the granules of plastics with static steps of immersion of the granules of plastics. In other words, during the emission of the ultrasonic waves into the tank, the liquid in contact with the granules of plastics may be stationary (zero velocity flow) and in this situation the contaminants may migrate from the granules to the liquid; after which, during a period of non-emission of the ultrasonic waves, the liquid is moved in the tank (for example by evacuating the liquid from the tank) and a liquid current is created that washes and/or rinses the plastics, taking away the contaminants dispersed in the liquid. The new liquid may then be returned to the tank (free of the contaminants), that, in contact with the plastics, enables a new decontamination cycle to be run with a static step of immersion of the plastics and emission of the ultrasonic waves.

This invention refers, in particular, to an apparatus and/or a method in which a process liquid (generally a liquid) is introduced into a tank to pass through incoherent plastics and is then extracted from the tank to be sent to a second tank. In the second tank it is possible to provide a purification of the liquid to make the liquid usable again to process the plastics (in particular in a closed circuit that reintroduces the purified liquid into the tank).

Further, it is possible to provide a stirring step for stirring the plastics in the tank. The stirring step enables the action of extracting the contaminant to be improved, in particular for certain plastics resins. The stirring step has to be controlled in order to avoid phenomena of degradation due to rubbing of the plastics. The stirring step may be performed by controlling one or more stirring parameters like, for example, a stirring time and/or a stirring speed. The stirring step may be performed by a mechanical stirrer. In particular, the stirring step may be performed by a stirrer. The stirring step may be performed by fluxing the liquid. Fluxing may be performed by moving and stirring the granules of plastics inside the tank.

One or more parameters of the decontamination process may vary on the basis of the type of plastics to be decontaminated. For example, for recycled polyethylene terephthalate (PET) the parameters may vary within the ranges set out below: temperature of the liquid in the tank between 25° C. and 200° C. (in particular between 50° C. and 200° C.), pressure in the tank between 1 bar and 300 bar (in particular between 5 bar and 230 bar), flowrate of the liquid between 1 l/min and 160 l/min, intensity of the ultrasound in continuous mode between 0.01 W/cm² and 100 W/cm² (in particular between 0.1 W/cm² and 10 W/cm², or between 1 W/cm² and 10 W/cm²), peak intensity of the ultrasound in pulsed mode between 0.1 W/cm² and 1000 W/cm² (in particular between 1 W/cm² and 100 W/cm², with average value comprised between 10 W/cm² and 50 W/cm²), processing time between 20 minutes and 240 minutes (if there are several repeated cycles, the sum of the times of the various cycles is considered).

The decontamination apparatus may comprise, in particular, a single decontamination unit, or two or more decontamination units, in particular arranged parallel and configured to operate in a reciprocal manner to ensure a constant flow of plastics for the subsequent process steps.

The decontamination apparatus may be controlled by a programmable electronic controller, for example a central unit CPU, configured to control at least one process parameter of the liquid and/or at least one process parameter of the ultrasonic waves on the basis of signals supplied by a sensor.

The emission of ultrasound, combined with the use of a liquid in which the plastics is immersed (in which the liquid may act, in particular, as a means for facilitating the transmission of the ultrasound), enables the contaminant substances to be moved from inside the granules of plastics, thus allowing effective decontamination of the granules.

The plastics, after being processed with ultrasonic waves (first process stage), may be subjected to a further decontamination process with gas in counter-current (second stage of process). In order to run this further process, the plastics may be transferred from the tank, where they have been treated with ultrasonic waves, to a container in which the plastics are made to descend from top to bottom, are hit by a counterflow process gas and are stirred by a stirrer. The process gas may be, for example, air (in particular, dehumidified air, for which humidity may be extracted from the plastics). Decontaminating with process gas in counter-current enables further contaminants to be extracted that were not extracted during processing with ultrasonic waves.

Decontaminating with process gas (second stage of treatment) can, in particular, also enable the granules of plastics to be dried. Decontaminating with process gas (second stage) may enable, in particular, the contaminants present on the surface of the granules of plastics to be eliminated, for example contaminants present in a liquid film that may still adhere to the surface of the granules of plastics exiting the tank for processing with ultrasonic waves (first stage). Decontaminating with process gas may be performed, for example, with the plastics contained inside a crystallizer. The process gas may be supplied by a dehumidifying system. For decontaminating with process gas, a gauge of volatile organic components (VOC) and/or of total organic carbon (TOC) and/or of one or more NIAS (acetaldehyde, benzene, toluene, limonene, etc) may be provided to monitor continuously the quality of the process gas used exiting the second decontamination/drying stage.

The process in the second decontamination/drying stage can avoid the risk of gluing or packing of polymer material, in particular in the presence of amorphous polymers or of polymers with a crystalline percentage below 30%, or below 20%, or below 10%.

The treatment in the second decontamination/drying stage can bring about regradation of the polymer material, increasing the intrinsic viscosity thereof up to values near those of a virgin resin.

The treatment in the second decontamination/drying stage may be performed with an open (or partially open) or closed process gas circuit. In the configuration with an open gas circuit process, the gas is sucked in from the environment and the gas used is returned to the environment, possibly after being subjected to a condensation process and/or to a filtering process (for example with active carbon filtering means). In the configuration with a partially open circuit, a part of the process gas is recirculated (which enables energy consumption to be reduced) and another part is discharged into the environment.

Decontaminating with process gas may be controlled on the basis of one or more crystallization parameters, in particular process temperature, gas flowrate, rotation speed of the mixing shaft, dwell time of the plastics in the crystallizer and/or treatment time and/or dewpoint of the process gas.

In one embodiment, the container (crystallizer) in the second stage, in order to increase the contaminants extraction capacity, may be provided with a plastics recirculating system, configured to take plastics from an outlet of the container and to return the plastics to an inlet of the container.

After decontaminating with process gas (second stage), the plastics exiting the container (crystallizer) may be subjected to a dehumidifying step with radio frequency (third stage). In particular, the plastics may be transferred to a hopper where they are made to descend from top to bottom, are hit by a process gas in counter-current and are heated by radio-frequency waves. Granules of plastics exiting the outlet may be obtained that are decontaminated and usable for food packaging, and dehumidified and usable for a subsequent process of extrusion transformation and/or moulding (for example injection moulding).

Further, it is possible to provide a final step (fourth stage) of cooling the plastics. The cooling step may be introduced to reduce the temperature of the plastics in order to enable the plastics to be stored and/or packed per future applications and/or for sale. The cooling step may be made by using a hopper in which a process liquid (gas, for example air) having a controlled temperature (temperature below that of the plastics) affects in counter-current the plastics. The cooling step may occur via a closed circuit of the process gas, in particular by using a gas flow generator and a system for lowering the temperature of the gas. Cooling may be achieved by an exchanger that modulates a flow of a cooling liquid in function of a temperature setpoint value of the process gas.

### BRIEF DESCRIPTION OF THE DRAWINGS

The invention can be better understood and implemented with reference to the enclosed drawings that illustrate embodiments by way of non-limiting example in which:

FIG. 1 is a diagram of one embodiment of an apparatus for decontaminating granules of plastics;

FIG. 2 is a diagram of a first embodiment of a multiple stage plant for treating granules of plastics;

FIG. 3 is a diagram of a second embodiment of a multiple stage plant for processing granules of plastics.

### DETAILED DESCRIPTION

For the sake of simplicity, in the attached figures similar elements of different embodiments have been indicated by the same numbering.

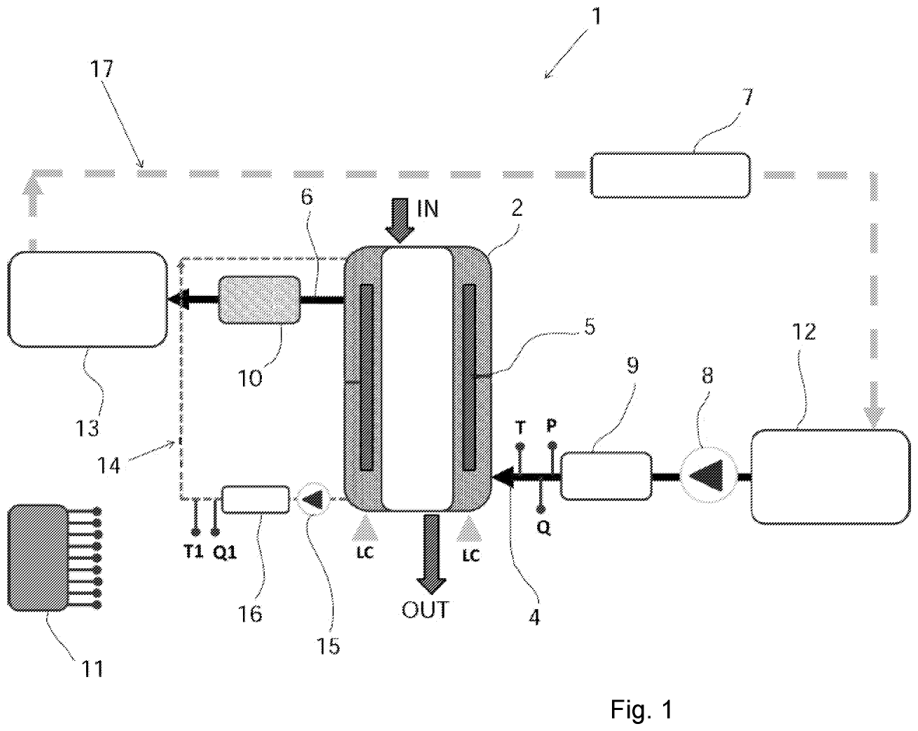

With reference to FIG. 1, a decontamination apparatus comprising at least a tank 2 configured to contain plastics in solid particulate form has been indicated overall with 1. The tank 2 may further comprise at least one (upper) inlet IN for loading the plastics and at least one (lower) outlet OUT for discharging the plastics. The tank 2 is configured, in particular, to permit a descending flow of plastics (for example, by gravity) from the inlet IN to the outlet OUT.

The decontamination apparatus 1 comprises at least one ultrasonic wave generator 5 configured to emit ultrasonic waves to the tank 2. The ultrasonic wave generator 5 may be, in particular, a generator of known type.

The decontamination apparatus 1 comprises a liquid circuit 17 for a process liquid. The liquid circuit 17 may comprise at least one supply duct 4 configured to feed a liquid, in particular a liquid (for example water), to the tank 2. The liquid circuit 17 may comprise at least one discharge duct 6 configured to discharge the liquid exiting the tank 2. The liquid circuit 17 may comprise purifier 7 configured to purify the liquid of at least one contaminant (for example, acetaldehyde, benzene, toluene, limonene, or other NIAS). The purifier 7 may comprise, in particular, a water purifier, for example a purifier with a reverse osmosis system and/or with an active carbon filter and/or with other technologies. The purifier 7 may be arranged so as to purify the liquid received from the discharge duct 6. In other words, the purifier 7 may be configured to purify the liquid exiting the tank 2, liquid containing at least one contaminant that can come from the plastics to be decontaminated, obtaining a purified liquid. The purifier 7 may be arranged so as to yield the purified liquid to the supply duct 4. In this manner, the purified liquid may be returned to the tank 2 so as to be able to reuse the purified liquid for a new decontamination cycle.

The liquid circuit 17 may comprise a feeder tank 12 connected to the supply duct 4. In particular, the feeder tank 12 is configured to contain the liquid that is supplied by the supply duct 4 to the tank 2. The feeder tank 12 may be connected to the purifier 7. The purifier 7 may be arranged to yield the purified liquid to the feeder tank 12. The feeder tank 12 may be arranged in the liquid circuit 17 between the purifier 7 and the plastics decontamination tank 2.

The tank 2 may be pressure-tight. The liquid circuit 17 may comprise feed means 8. The feed means 8 is configured to supply liquid under pressure to the tank 2. In particular, the feed means 8 is configured to supply under pressure (at a pressure above atmospheric pressure) the liquid from the feeder tank 12 to the tank 2. The feed means 8 is configured to control the pressure and/or the flowrate of the liquid into the plastics decontamination tank 2. The feed means 8 may comprise, for example, at least one pump (for example an electric pump).

The apparatus 1 may comprise a heater 9. The heater 9 is configured to heat the liquid entering the tank 2. The heater 9 may be arranged downstream of the feeder tank 12 (as in the illustrated embodiment, the heater 9 may be arranged between the feeder tank 12 and the plastics decontamination tank 2). The heater may be arranged in the feeder tank. The heater 9 may be arranged in the liquid circuit 17, before the tank 2. In particular, the supply duct 4 may comprise the heater 9. The heater may be arranged in the feeder tank 12 and/or in the plastics decontamination tank 2. The heater 9 is configured to control the temperature of the liquid in the tank 2 (for example by a thermostat). The heater 9 may comprise, for example, an electric or other type of heater.

The apparatus 1 may comprise, in particular, an auxiliary circuit 14 of the liquid configured so as to remove liquid from the tank 2 and to return the liquid to the tank 2. The auxiliary circuit 14 comprises a liquid circulation pump 15 and a heater 16 for heating the liquid. The heater 16 may be, in particular, thermostated to maintain the liquid at a desired temperature. The liquid circulation pump 15 may be controlled on the basis of a desired flowrate value of the liquid. The liquid in the auxiliary circuit 14 may be recirculated during the emission of the ultrasonic waves.

The apparatus 1 may comprise a detector 10 configured to detect an amount of at least one contaminant (for example, acetaldehyde, benzene, toluene, limonene, or other NIAS) present in the liquid exiting the tank 2. The detector 10 may be arranged in the liquid circuit 17 downstream of the tank 2. The detector 10 may comprise, in particular, a gas chromatography analyzer.

The apparatus 1 may comprise one or more sensors like, for example, a temperature sensor T to detect the temperature of the liquid entering the tank 2, a pressure sensor P to detect the pressure of the liquid entering the tank 2, a flowrate sensor Q to detect the flowrate of the liquid entering the tank 2, a temperature sensor T1 to detect the temperature of the liquid in the auxiliary circuit 14, a flowrate sensor Q1 to detect the flowrate of the liquid in the auxiliary circuit 14, one or more load cells LC to enable the weight of the plastics in the tank 2 to be weighed. The apparatus 1 may comprise, in particular, at least one load cell LC configured to weigh the content of the tank 2. The tank 2 may comprise at least two load cells LC.

The apparatus 1 may comprise a programmable electronic controller 11 configured to control at least one process parameter of the liquid (in particular, in the tank 2 and/or in the liquid circuit 17) and/or at least one process parameter of the ultrasonic waves. The programmable electronic controller 11 may be configured, in particular, to control the aforesaid process parameter on the basis of signals supplied by the detector 10. In other words, the controller 11 controls with feedback regulation at least one process parameter on the basis of the amount of at least one contaminant detected in the liquid exiting the tank 2.

The aforesaid process parameter is included, in particular, in a set of parameters comprising: pressure of the liquid in the tank 2, temperature of the liquid in the tank 2, flowrate of the liquid through the tank 2, dwell time of the liquid and/or of the plastics in the tank 2, intensity of the ultrasonic waves, frequency of the ultrasonic waves. The programmable electronic controller 11 may comprise a CPU.

The apparatus 1 may comprise a sensor (which is not shown, for example a sensor of gas chromatography type) configured to detect an amount of at least one contaminant (in particular, acetaldehyde and/or benzene and/or limonene and/or toluene and/or other NIAS) present in the plastics introduced into the tank 2. The programmable electronic controller 11 may be configured to control the aforesaid process parameter of the liquid and/or of the ultrasonic waves on the basis of signals supplied by the aforesaid sensor. The sensor may be arranged upstream of the tank 2 or be arranged in the tank 2.

The tank 2 may further comprise means for heating the tank 2 that may comprise, in particular, a coil that is not shown inside which a heating liquid flows. The means for heating the tank 2 may be thermostated. The means for heating the tank 2 may be configured to maintain constant the temperature of the tank 2. In particular, the means for heating may be configured to heat the plastics loaded inside the tank, accelerating heating times. The means for heating the tank 2 may be arranged inside and/or outside the tank 2.

The liquid circuit 17 may comprise, in particular, a storage tank 13 for storing the used liquid exiting the tank 2. The storage tank 13 may be arranged, as in the illustrated embodiment, between the decontamination tank 2 (in particular, after the detector 10) and the purifier 7.

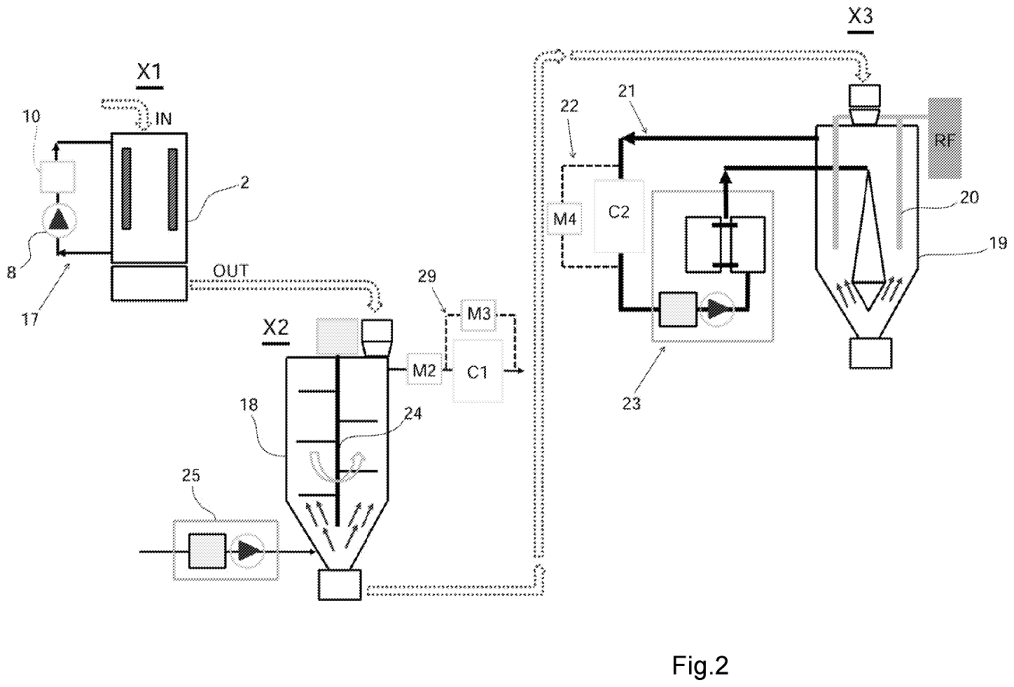

With reference to FIG. 2, a decontamination plant for decontaminating plastics in particle form is shown. The decontamination plant comprises various process stages. A first process stage X1 comprises a plastics decontamination apparatus in which the plastics is immersed in a process liquid and is hit with ultrasound. The decontamination apparatus may comprise, in particular, a decontamination apparatus 1 as disclosed previously.

A second stage X2 comprises a container 18 configured to contain the plastics. The container 18 may be arranged downstream of the decontamination apparatus 1 to receive the plastics coming from the decontamination apparatus 1. The container 18 is so configured that the plastics that enters the container 18 is made to descend from the top to the bottom, is hit by a process gas and is stirred by a stirrer 24. The stirrer 24 may be for example a stirrer equipped with blades that keep the plastics moving to prevent the creation of lumps. The second stage X2 comprises a generator 25 configured to generate a flow of process gas to feed the process gas (for example air) into the container 18. The generator 25 may comprise, in particular, a fan. The generator 25 may comprise, in particular, an air filter. Treating the plastics inside the container 18 may comprise, in particular, crystallization.

The second stage X2 may comprise a circuit 29 of the process gas exiting the container 18. The circuit 29 of the process gas exiting may be an open circuit or a partially open circuit or a closed circuit. The circuit 29 may comprise, in particular, a detector of the contaminants M2 of the process gas exiting the container 18. The circuit 29 may comprise, in particular, a condenser C1 configured to condense volatile substances contained in the used process gas. The circuit 29 may comprise, in particular, an active carbon filter M3 to retain one or more contaminants contained in the used process gas. The process gas may then be sent to an environment outside the container 18 or may be recirculated (totally or partially) in the container 18.

A third stage X3 comprises a hopper 19 arranged downstream of the container 18 to receive the plastics coming from the container 18 of the second stage. The hopper 19 is so configured that the plastics that enters the hopper 19 is made to descend from the top to the bottom, is hit in counter-current by a process gas and is heated by radio-frequency waves. The third stage X3 comprises a radio frequency generator RF and one or more electrodes 20 arranged in the hopper 19 to emit radio-frequency waves. The third stage X3 comprises a treatment circuit 21 configured to remove process gas exiting the hopper 19, to decontaminate and/or dehumidify the process gas and to then return the process gas to the hopper 19. The treatment circuit 21 comprises a decontamination device 22 configured to process the used process gas coming from the hopper. The decontamination device 22 may comprise at least one condenser C2 configured to condense volatile substances contained in the used process gas. The decontamination device 22 may comprise at least one active carbon filter M4 to retain one or more contaminants contained in the used process gas. The treatment circuit 21 comprises a dehumidifying device 23 configured to dehumidify the process gas. The dehumidifying device 23 may comprise, in particular, two dehumidifying units arranged parallel, for example of the type with molecular screens, used with cycles that alternate dehumidifying steps and regenerating steps.

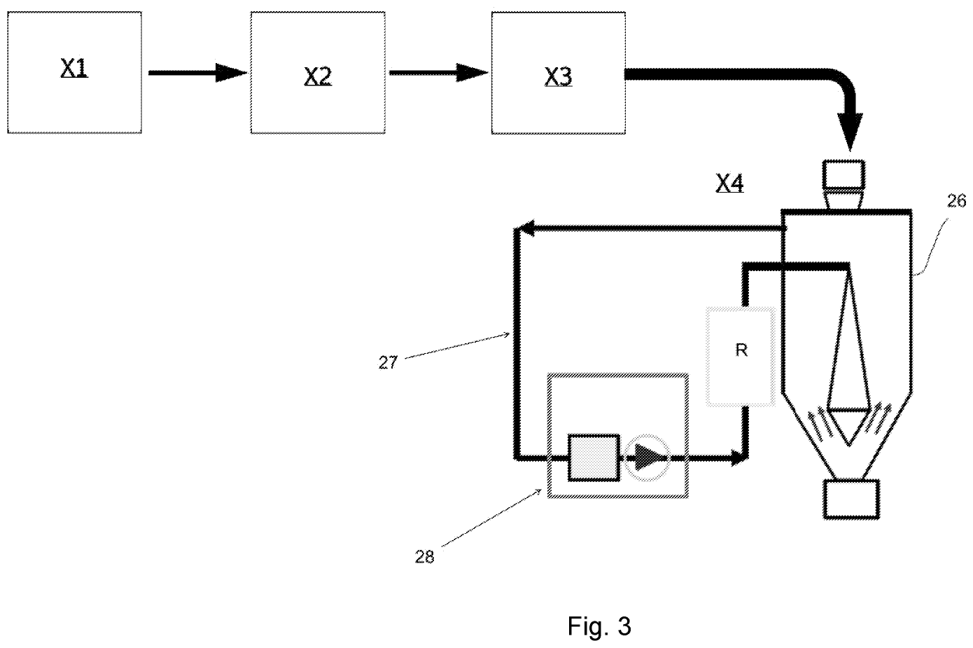

With reference to FIG. 3, a decontamination plant for decontaminating plastics in particle form is shown comprising a fourth process stage X4. In particular, the plant may comprise the fourth stage X4 to cool the decontaminated plastics. The fourth stage X4 comprises a cooling hopper 26. The cooling hopper 26 may be arranged downstream of the hopper 19 to receive the plastics coming from the hopper 19 of the third stage X3. The cooling hopper 26 is so configured that the plastics that enters the cooling hopper 26 is made to descend from the top to the bottom, is hit in counter-current by a process gas having a lower temperature than the temperature of the plastics to be cooled. The fourth stage X4 comprises a cooling circuit 27 for cooling the process gas. The cooling circuit 27 may be a closed circuit configured to remove the process gas exiting the cooling hopper 26, cool the process gas and return the process gas to the cooling hopper 26. The cooling circuit 27 comprises a generator 28 of a flow of process gas and a reduction system R for lowering the temperature of the process gas. The reduction system R may be, for example, a heat exchanger with a cooling liquid.

The operation of the decontamination apparatus 1 actuates a decontaminating method disclosed below. The decontaminating method comprises the step of loading plastics in solid particulate form into the tank 2. The plastics in solid particulate form may be plastics. In particular, the plastics in solid particulate form may be recycled plastics. The plastics are, for example, plastics in the form of granules, microgranules, pellets, powder, flakes and the like obtained from recycled plastics that have undergone an extrusion treatment and/or other waste sorting and/or washing and/or decontamination and/or deodorization treatments.

The method comprises the step of introducing a process liquid in the tank 2 so that the liquid is in contact with the plastics, so that the plastics may be immersed in the liquid. The tank 2 may be pressure-tight. The liquid may be a liquid. The liquid may be water or a water-based solvent, for example a water-based solvent with 90% ethanol (v/v), ethyl acetate and hexane.

The method comprises the hitting step of hitting both the plastics in the tank 2, and the liquid in contact with the plastics, with ultrasonic waves. In the hitting step, the ultrasonic waves may be modulated continuously or in pulse trains. In the hitting step, the liquid in the tank 2 may be stationary. The liquid in the tank 2 may be in pressurized during the hitting step. After the hitting step, the liquid may be made to flow out of the tank 2. The flow of the liquid in the tank 2 promotes the extraction and removal of the contaminant from the plastics. The contaminant is dragged by the liquid exiting the tank 2.

The method may comprise the detecting step of detecting an amount of at least one contaminant present in the liquid exiting the tank 2. In the process, the contaminants are transferred from the plastics to the liquid, so one or more contaminants are present in the liquid that is discharged from the tank 2. The contaminant the amount of which is detected in the exiting liquid may comprise one or more contaminants included in the set that comprises acetaldehyde, benzene, limonene, toluene and other NIAS. The step of detecting the amount of contaminant may be implemented by the detector 10.

The method may comprise the step of purifying the liquid exiting the tank 2 to obtain a purified liquid. The method may comprise the step of introducing the purified liquid into the tank 2. The purified liquid may then be introduced again into the tank 2 to come into contact with the plastics, so that the plastics in the tank 2 and the purified liquid in contact with the plastics is hit with ultrasonic waves. In other words, the liquid exiting the tank 2 may be purified and then recirculated and reused for a further decontamination cycle.

The method may comprise the step of controlling at least one process parameter of the purified liquid and/or at least one process parameter of the liquid in the tank 2 and/or at least one process parameter of the ultrasonic waves emitted in the tank 2, on the basis of the amount of at least one contaminant detected in the exiting liquid. The aforesaid process parameter is included in a set of process parameters comprising: pressure of the liquid in the tank 2, temperature of the liquid in the tank 2, flowrate of the liquid through the tank 2, dwell time of the liquid and/or of the plastics in the tank 2, intensity of the ultrasonic waves, frequency of the ultrasonic waves. In particular, the method may comprise the step of controlling the temperature of the liquid in the tank 2 on the basis of the amount of contaminant detected in the exiting liquid. In particular, the method may comprise the step of controlling the pressure of the liquid in the tank 2 (with pressure regulating means, for example of known type) on the basis of the amount of contaminant detected in the exiting liquid. In particular, the method may comprise the step of controlling the dwell time of the plastics in the tank 2 on the basis of the amount of contaminant detected in the exiting liquid. In particular, the method may comprise the step of controlling the intensity and/or the frequency of the ultrasonic waves on the basis of the amount of contaminant detected in the exiting liquid.

The method may comprise, in particular before the step of loading the plastics into the tank 2, the detecting step of detecting an amount of contaminant, in particular acetaldehyde and/or benzene and/or limonene and/or toluene and/or other NIAS, present in the plastics. The method may further comprise the step of controlling at least one process parameter of the liquid and/or of the ultrasonic waves on the basis of the amount of at least one contaminant detected in the plastics.

If the amount of contaminants present in the plastics to be decontaminated is known, some process parameters may be controlled. It is possible, in particular, to control the treatment time on the basis of the amount of contaminants present in the plastics to be decontaminated. It is in particular possible to control the temperature of the liquid on the basis of the amount of contaminants present in the plastics to be decontaminated. It is in particular possible to control the pressure of the liquid on the basis of the amount of contaminants present in the plastics to be decontaminated. It is in particular possible to control the flowrate of the liquid on the basis of the amount of contaminants present in the plastics to be decontaminated. It is in particular possible to control at least one operating parameter of the ultrasonic waves emitted in the tank 2 on the basis of the amount of contaminants present in the plastics to be decontaminated.

In particular, the process parameters may be controlled in the following ranges, particularly suitable for processing recycled polyethylene terephthalate (PET): temperature of the liquid and/or of the plastics in the tank 2 between 25° C. and 200° C. (in particular between 50° C. and 200° C.), pressure in the tank 2 between 1 bar and 300 bar (for example between 5 bar and 230 bar), flowrate of the liquid between 1 l/min and 160 l/min, intensity of the ultrasound in continuous mode between 0.01 W/cm² and 100 W/cm² (for example between 1 W/cm² and 10 W/cm²), peak intensity of the ultrasound in pulsed mode between 0.1 W/cm² and 1000 W/cm², in particular between 1 W/cm² and 100 W/cm² (with average value comprised between 10 W/cm² and 50 W/cm²), treatment time between 20 minutes and 240 minutes (totaling the times of the various cycles in the case of several repeated cycles); frequency of the ultrasound between 10 KHz and 160 KHz.

Further, knowing the amount of contaminants present in the liquid exiting the tank 2 and knowing the amount of contaminants in the plastics before the decontamination treatment, it may be established how many contaminants are still present in the plastics after a decontamination cycle and it may be accordingly established whether or not to perform further decontamination cycles in order to obtain a desired degree of decontamination of the plastics.

The method may comprise, in particular at least during the hitting step, the stirring step of stirring plastics in the tank 2. In other words, the method may comprise the stirring step of stirring plastics in the tank 2 and this stirring step of stirring plastics may be actuated, for example, during the emission step of emitting the ultrasonic waves. The stirring step may be actuated, for example, to facilitate extracting and detaching contaminant from the plastics so that the contaminant is lost in the liquid. The stirring step may be actuated by a stirrer (which is not illustrated, for example of known type), in particular a mechanical stirrer, a stirrer with blades or by another type. The stirrer can, for example, act directly on the plastics. The stirring step may be actuated by fluxing the liquid, i.e. the liquid is moved inside the tank so as to create a mixing flow.

The plastics to be decontaminated may comprise, for example, plastics obtained from post-consumer resin PCR (in particular in the form of granules obtained from an extrusion system). In particular, the plastics may be recycled PET and/or recycled polyolefins (for example recycled PP and/or recycled PE).

The operation of the multistage decontamination plant actuates a decontaminating method that comprises the step of discharging the plastics exiting the tank 2 of the decontamination apparatus 1 that is part of the first stage X1. The plastics may be transferred from the tank 2 of the first stage X1 to the container 18 of the second stage X2, in which the plastics is made to descend from the top to the bottom, is hit by a process gas in counter-current and is stirred by a stirrer 24. The process gas used in the second stage X2 may be a controlled temperature. The process gas may be used to eliminate further contaminants from the plastics. Further, the process gas may eliminate humidity from the plastics exiting the tank 2. The process gas may be for example air and/or an inert gas. It is possible to recirculate the plastics in the container 18, in which the plastics exiting the container is returned (at least partially) to the container 18 to then again be made to descend from the top to the bottom, hit in counter-current by the process gas and stirred by the stirrer 24.

The plastics may be transferred from the container 18 of the second stage X2 to the hopper 19 of the third stage X3, where the plastics is made to descend from the top to the bottom, is hit by a process gas in counter-current and is heated by radio-frequency waves. In such steps, extracting continues of possible contaminants present in the plastics, which is, further, dehumidified. The process gas used in the third stage X3 may be for example air and/or an inert gas.

At the outlet from the hopper 19, granules of decontaminated and dehumidified plastics usable for food packaging may be obtained.

The plastics exiting the hopper 19 of the third stage X3 may be transferred to a machine for a subsequent extrusion and/or moulding process, for example may be transferred to a machine to process the plastics by injection-moulding.

Further, the plastics exiting the hopper 19 may be transferred to the cooling hopper 26 of the fourth stage X4, where the plastics is made to descend from the top to the bottom, is hit by a process gas in counter-current at a controlled temperature, in particular a temperature below the temperature of the plastics. The cooling step may be introduced to reduce the temperature of the plastics in order to enable the plastics to be stored and/or packed for future applications and/or for sale. The process gas used in the fourth stage X4 may be for example dehumidified air and/or dried air and/or an inert gas, for example nitrogen.

1.-20. (canceled)

21. Method of decontamination comprising the steps of:
loading plastics in solid particulate form into a tank;
introducing a liquid into the tank so that the liquid is in contact with the plastics; and
hitting the plastics in the tank and the liquid in contact with the plastics with ultrasonic waves.

22. Method according to claim 21, wherein the tank is pressure-tight and the liquid in the tank is under pressure during the hitting step.

23. Method according to claim 21, comprising the steps of purifying the liquid exiting the tank to obtain a purified liquid, introducing the purified liquid into the tank and hitting the plastics in the tank and the purified liquid in contact with the plastics with ultrasonic waves.

24. Method according to claim 23, comprising the steps of detecting an amount of at least one contaminant present in the liquid exiting the tank, and of controlling at least one process parameter of the purified liquid and/or at least one process parameter of the liquid in the tank and/or at least one process parameter of the ultrasonic waves based on the amount of at least one contaminant detected in the liquid exiting the tank.

25. Method according to claim 24, wherein the at least one contaminant comprises acetaldehyde and/or benzene and/or limonene and/or toluene and/or other NIAS.

26. Method according to claim 24, wherein the at least one process parameter is included in a set of process parameters comprising: pressure of the liquid in the tank, temperature of the liquid in the tank, flowrate of the liquid through the tank, dwell time of the liquid and/or the plastics in the tank, intensity of the ultrasonic waves, frequency of the ultrasonic waves, emission ratio of the ultrasonic waves.

27. Method according to claim 21, comprising, before the step of loading the plastics into the tank, the step of detecting an amount of at least one contaminant present in the plastics and the step of controlling at least one process parameter of the liquid and/or of the ultrasonic waves based on the amount of at least one contaminant detected in the plastics.

28. Method according to claim 27, wherein the at least one contaminant comprises acetaldehyde and/or benzene and/or limonene and/or toluene and/or other NIAS.

29. Method according to claim 21, comprising, at least during the hitting step, the step of stirring the plastics in the tank; the stirring step being carried out by a stirrer and/or by flushing the liquid.

30. Method according to claim 21, wherein the plastics comprises recycled post-consumer plastics PCR.

31. Method according to claim 21, wherein the plastics is transferred from the tank to a container in which the plastics is made to descend from top to bottom, is hit in counter-current by a process gas and is stirred by a stirrer.

32. Method according to claim 31, wherein the plastics is transferred from the container to a hopper where the plastics is made to descend from top to bottom, is hit in counter-current by a process gas and is heated by radio frequency waves.

33. Method according to claim 21, wherein the liquid is water or a water-based solvent.

34. Decontamination apparatus comprising:
at least one tank configured to contain plastics in particulate solid form;
at least one ultrasonic wave generator configured to emit ultrasonic waves into the at least one tank;
a liquid circuit with at least one supply duct configured to feed a liquid into the at least one tank, with at least one discharge duct configured to discharge the liquid exiting the at least one tank, and with a purifier configured to purify the liquid from at least one contaminant and arranged so as to purify the liquid received from the at least one discharge duct and to release the purified liquid to the at least one supply duct.

35. Apparatus according to claim 34, wherein the tank is pressure-tight and the liquid circuit is configured to supply liquid under pressure to the tank.

36. Apparatus according to claim 34, comprising a heater for heating the liquid in the tank.

37. Apparatus according to claim 34, comprising a sensor configured to detect an amount of at least one contaminant present in the liquid exiting the tank, and a programmable electronic controller configured to control at least one process parameter of the liquid in the tank and/or in the liquid circuit and/or at least one process parameter of the ultrasonic waves, based on signals provided by the sensor; the at least one process parameter being included in a set of parameters comprising: pressure of the liquid in the tank, temperature of the liquid in the tank, flowrate of the liquid through the tank, dwell time of the liquid and/or the plastics in the tank, intensity of the ultrasonic waves, frequency of the ultrasonic waves, emission ratio of the ultrasonic waves.

38. Apparatus according to claim 34, comprising a sensor configured to detect an amount of at least one contaminant present in the plastics contained in the tank and an electronic controller configured to control at least one process parameter of the liquid and/or of the ultrasonic waves on the basis of signals provided by the sensor.

39. Decontamination plant comprising a decontamination apparatus and a container arranged downstream of the decontamination apparatus to receive plastics coming from the decontamination apparatus, the decontamination apparatus being made according to claim 34, the container being configured in such a way that plastics entering the container is to descend from top to bottom, is hit in counter-current by a process gas and is stirred by a stirrer.

40. Plant according to claim 39, comprising a hopper arranged downstream of the container to receive the plastics coming from the container, the hopper being configured in such a way that the plastics entering the hopper is made to descend from top to bottom, is hit in counter-current by a process gas and is heated by radio frequency waves.
